(19) United States
(12) Patent Application Publication
(10) Pub. No.: US 2025/0028310 A1
(43) Pub. Date: Jan. 23, 2025

(54) ENHANCED VIBRATION MONITORING USING MACHINE LEARNING

(71) Applicant: Saudi Arabian Oil Company, Dhahran (SA)

(72) Inventors: Doru Catalin Turcan, Dhahran (SA); Saad Hamad Dossary, Dhahran (SA); Amer Abdulrahman Alamer, Dammam (SA); Fawaz Saleh Alshammary, Dammam (SA)

(21) Appl. No.: 18/355,843

(22) Filed: Jul. 20, 2023

(51) Int. Cl. G05B 23/02; G01M 1/22

(52) U.S. Cl. CPC G05B 23/024; G01M 1/22; G05B 2223/02

(57) ABSTRACT

A computer-implemented method includes: accessing streams of data encoding measurements taken at one or more pieces of rotating equipment; accessing a database encoding past measurement records from the one or more pieces of rotating equipment; identifying, using a machine learning (ML) module, relevant ranges of measurement values for at least a portion of the measurements, wherein the ML module is adapted to predict the relevant ranges of measurement values; extracting a subset of the at least a portion of the measurements, wherein the subset is identified by the ML module as more capable of distinguishing between normal and abnormal operating conditions for the one or more pieces of rotating equipment; and generating, on a display device, at least one plot based on the subset within the relevant ranges of measurement values such that the one or more pieces of rotating equipment are monitored continuously for deviations from the normal operating conditions.

### TECHNICAL FIELD

This disclosure generally relates to monitoring the vibration pattern of rotary machinery and analyzing the vibration pattern.

### BACKGROUND

A rotary machinery is often used in the industry in association with high-performance machinery protection systems that include sophisticated condition monitoring software. Yet, the machinery protection system can still fail to indicate faulty conditions. As a result, these faulty conditions can lead to production related concerns that hinder the reduction of the operating expense and the savings on energy consumption.

### SUMMARY

In one aspect, a computer-implemented method that includes: accessing streams of data encoding measurements taken at one or more pieces of rotating equipment; accessing a database encoding past measurement records from the one or more pieces of rotating equipment; identifying, using a processor configured to operate a machine learning (ML) module, relevant ranges of measurement values for at least a portion of the measurements encoded by the streams of data, wherein the ML module is adapted to predict the relevant ranges of measurement values based on, at least in part, the past measurement records from the one or more pieces of rotating equipment; extracting, using the processor configured to operate the machine learning (ML) module, a subset of the at least a portion of the measurements, wherein the subset is identified by the ML module as more capable of distinguishing normal and abnormal operating conditions for the one or more pieces of rotating equipment than a remainder of the at least a portion of the measurements; and generating, on a display device, at least one plot based on the subset of the at least a portion of the measurements and within the relevant ranges of measurement values such that the one or more pieces of rotating equipment are monitored continuously for deviations from the normal operating conditions.

Implementations may include one or more of the following features.

The measurements may be taken from a plurality of sensors disposed at the one or more pieces of rotating equipment, a phase reference sensor disposed at the one or more pieces of rotating equipment. The streams of data may include process data associated with the one or more pieces of rotating equipment. The method may further include: comparing a measured phase based on the measurements from at least one of the plurality of sensors and a reference phase from the phase reference sensor; and generating at least one measurement based on results of comparing the measured phase and the reference phase. The plurality of sensors may include at least one of: an accelerometer, a velocity sensor, a displacement sensor, a proximity sensor, and a strain gauge. The process data associated with the one or more pieces of rotating equipment may include: a flow rate, a pressure, a temperature, and a valve position. The method may further include: building the database that correlates the past measurement records from the one or more pieces of rotating equipment with operating conditions of the one or more pieces of rotating equipment. Building the database may further include: receiving, from an analyst, data encoding a determination by the analyst that correlates at least one of the past measurement records from the one or more pieces of rotating equipment with at least one of the operating conditions of the one or more pieces of rotating equipment. The relevant ranges of measurement values may cover a temporal range in addition to a vertical range for the measurement values. The subset of the at least a portion of the measurements may include: a shaft centerline plot, an orbit plot, a Bode plot, a polar plot, a waterfall plot, a trend plot, and a trend plot. The generating may provide, on the display device, two or more plots based on the subset, wherein the two or more plots are generated dynamically as the one or more pieces of rotating equipment are operating.

In another aspect, the implementations provide a computer system comprising one or more computer processors configured to operate a machine learning (ML) module and perform operations of: accessing streams of data encoding measurements taken at one or more pieces of rotating equipment; accessing a database encoding past measurement records from the one or more pieces of rotating equipment; identifying relevant ranges of measurement values for at least a portion of the measurements encoded by the streams of data, wherein the ML module is adapted to predict the relevant ranges of measurement values based on, at least in part, the past measurement records from the one or more pieces of rotating equipment; extracting a subset of the at least a portion of the measurements, wherein the subset is identified by the ML module as more capable of distinguishing between normal and abnormal operating conditions for the one or more pieces of rotating equipment than a remainder of the at least a portion of the measurements; and generating, on a display device, at least one plot based on the subset of the at least a portion of the measurements and within the relevant ranges of measurement values such that the one or more pieces of rotating equipment are monitored continuously for deviations from the normal operating conditions.

Implementations may include one or more of the following features.

The measurements may be taken from a plurality of sensors disposed at the one or more pieces of rotating equipment, a phase reference sensor disposed at the one or more pieces of rotating equipment. The streams of data may include process data associated with the one or more pieces of rotating equipment. The operations may further include: comparing a measured phase based on the measurements from at least one of the plurality of sensors and a reference phase from the phase reference sensor; and generating at least one measurement based on results of comparing the measured phase and the reference phase. The plurality of sensors may include at least one of: an accelerometer, a velocity sensor, a displacement sensor, a proximity sensor, and a strain gauge. The process data associated with the one or more pieces of rotating equipment may include: a flow rate, a pressure, a temperature, and a valve position. The operations may further include: building the database that correlates the past measurement records from the one or more pieces of rotating equipment with operating conditions of the one or more pieces of rotating equipment. Building the database may further include: receiving, from an analyst, data encoding a determination by the analyst that correlates at least one of the past measurement records from the one or more pieces of rotating equipment with at least one of the operating conditions of the one or more pieces of rotating equipment. The relevant ranges of measurement values may cover a temporal range in addition to a vertical range for the measurement values. The subset of the at least a portion of the measurements may include: a shaft centerline plot, an orbit plot, a Bode plot, a polar plot, a waterfall plot, a trend plot, and a trend plot. The generating may provide, on the display device, two or more plots based on the subset, wherein the two or more plots are generated dynamically as the one or more pieces of rotating equipment are operating.

Implementations according to the present disclosure may be realized in computer implemented methods, hardware computing systems, and tangible computer readable media. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The subject matter described in this specification can be implemented to realize one or more of the following advantages. First, various steps of the implementation cannot be performed in the human mind. For example, the implementations operate to acquire voluminous real-time measurements from sensors strategically disposed at one or more pieces of rotating equipment. The speed and volume of measurements that are acquired from these sensors in real-time render the human mind impractical for processing. Second, the implementations provide a practical application of continuously monitoring one or more pieces of rotating equipment in which the range of measurement values and the type of plot on display are adjusted dynamically by leveraging past records using machine learning (ML) capabilities. As explained in more detail below, the practicable application is provided as an add-on module to a general monitoring software. The added capability of automatically and dynamically adjusting plots adds significantly more to the general monitoring software so that the relevant ranges of measurements are provided using a distinguishing type of plot based on harvesting past records and leveraging machine learning features of the present disclosure.

The details of one or more implementations of the subject matter of this specification are set forth in the description, the claims, and the accompanying drawings. Other features, aspects, and advantages of the subject matter will become apparent from the description, the claims, and the accompanying drawings.

### DESCRIPTION OF DRAWINGS

FIG. 1 illustrates an example of a system diagram for enhanced vibration monitoring according to some implementations of the present disclosure.

FIG. 2 illustrates an example of input data according to some implementations of the present disclosure.

FIG. 3 illustrates a system diagram for enhanced vibration monitoring according to some implementations of the present disclosure.

FIGS. 4A-4B illustrate examples of output plots according to some implementations of the present disclosure.

FIGS. 5A-5B illustrate examples of input data with transient event that can evade analysis in the absence of implementations of the present disclosure.

FIGS. 6-7 illustrate examples of system diagrams according to some implementations of the present disclosure.

FIG. 8 is a block diagram illustrating an example of a computer system used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

Within the confines of the present disclosure, the terms of “machine learning” (ML), “artificial intelligence” (AI), and “deep learning” (DL) are used interchangeably to refer to a methodology to train a statistical model based on a training set of input data so that, when the statistical model is applied to new input data, the new input data can be classified according to differentiating features revealed by the statistical model.

In the context of operating industrial facilities, increasing industrial equipment reliability while reducing operating costs such as realizing energy savings are becoming more prevalently acknowledged. The implementations of the present disclosure improve vibration monitoring, for example, at industrial facilities. The implementations provide a plotting tool packaged as a virtual module within a vibration condition monitoring software based on Machine Learning (ML) and Artificial Intelligence (AI). Using the ML/AI capabilities, the implementations operate to select relevant plots from incoming streams of data (e.g., sensor data), and build sets of plots based on the underlying machine's running condition/mode to facilitate vibration monitoring. For example, the virtual module operates to determine the critical range of dynamic and static data such as vibration signals, phase reference signals, process data (e.g., flow rates, pressures, temperatures, and valve position). In some cases, the plotting tool operates to establish baseline vibration patterns for comparison with later patterns when monitoring a rotating component. The virtual module can also set up and actively adjust software alarming levels. In summary, the plotting tool operates to determine the critical data range, the more relevant data type to consider, and the plot type with more statistical power to distinguish normal and abnormal conditions. The plotting tool provide the more relevant vibration information in a fast and reliable manner to prompt and guide users who analyze the data. The plotting tool, however, does not determine the type of fault(s).

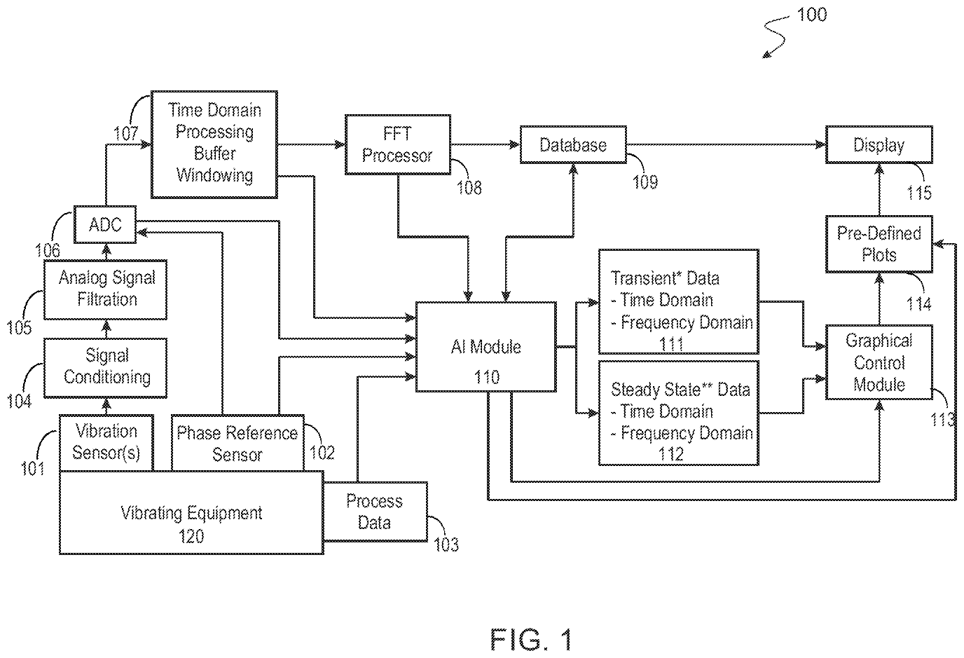

By way of background, while rotating equipment used by the industry are often equipped with high performance machinery protection systems with sophisticated condition monitoring software, the protection systems can still fail to indicate critical developing conditions, resulting in production related concerns with negative impacts on the cost and energy savings when operating the industrial facilities. In comparison, the techniques used by implementations of the present disclosure can utilize the vast amount of available data, such as streams input data from sensors that monitor vibrational patterns at various locations. Using the disclosed techniques, implementations of the present disclosure can continuously monitor streams of measurements data taken from sensors disposed to monitor vibration patterns of one or more pieces of rotating equipment, execute specific functions in accordance with internal instructions to identify abnormal operating conditions, and display relevant plots. The implementations also provide dynamic reconfiguration of data acquisition parameters in view of the machine's condition/process. The implementations can also perform automatic determination of transient conditions' time periods, and provide automatic display of case relevant plots. Further, the implementations can forecast the timing to reach alarm levels, indicating the condition parameters and display relevant plots. Using the AI/ML features, the implementations can learn to identify incipient or developing failures and will present these identified failures accordingly, based on the existing historical data and the data differentiation features. Moreover, the implementations can leverage the AI/ML features to learn to identify transient data due to conditions such as load variation. Details of the implementations are provided below, in association with FIGS. 1-8.

FIG. 1 illustrates an example of a system diagram 100 according to some implementations of the present disclosure. Vibration equipment 120 can include a machinery with a rotating part, such as a rotary shaft. Vibration equipment 120 is often employed in an industry facility. In the illustration, vibration sensor 101, phase difference sensor 102 are disposed on a piece of vibrating equipment.

Examples of vibration sensor 101 can include accelerometers, velocity sensors, displacement sensors, proximity sensors, and strain gauges. By way of illustration, when accelerometers can measure the acceleration of a vibrating object, which is then converted into velocity or displacement for analysis. Some implementations incorporate piezoelectric accelerometers that can generate a voltage proportional to the acceleration. Accelerometers are available in various configurations, including single-axis, triaxial (measuring acceleration in three perpendicular axes), and miniature versions for space-constrained applications. Velocity sensors, also known as seismometers or geophones, measure the velocity of an object's motion. They are based on the principle of electromagnetic induction or the moving-coil mechanism. Velocity sensors are useful for monitoring low-frequency vibrations and are less sensitive to high-frequency noise compared to accelerometers. Displacement sensors can measure the displacement or movement of an object. For example, displacement sensors are capable of capturing very low-frequency vibrations or when direct displacement measurements may be required. Eddy current displacement sensors and laser displacement sensors are examples used for this purpose. Proximity probes are used to measure the distance or gap between the probe tip and a rotating shaft. They are particularly useful for monitoring machinery with rotating parts, such as turbines or large motors. Proximity probes are typically used in conjunction with shaft vibration measurements to detect radial vibrations and eccentricity. Strain gauges are sensors that measure the deformation or strain in an object when subjected to mechanical stress. Strain gauges are often used for monitoring specific components or structures within machinery, such as bearing housings or critical structural elements.

Phase reference sensor 102, also known as a reference accelerometer or reference transducer, is an additional sensor used in conjunction with other vibration sensors for certain applications. Phase reference sensor 102 can provide a stable reference point or phase reference against which the vibration signals from other sensors can be compared. This reference can assist in analyzing the relative phase relationships between different points on a machine or structure. For example, the signals from the reference sensor and other sensors can be compared to determine the phase relationships. The phase information can reveal the relative timing and synchronization of vibrations at different measurement points. The phase reference sensor 102 is often used in cases where the vibration response of different measurement points needs to be compared, synchronized, or analyzed for troubleshooting or condition monitoring purposes. In these applications, phase reference sensor 102 can provide a consistent reference for evaluating the phase relationships and identifying potential problems.

Process data 103 can refer to the data related to the operation and performance of the vibrating equipment 120 that is being monitored. Process data 103 can encompass various parameters and measurements that characterize the equipment's behavior, condition, and associated processes. Process data 103 can be collected alongside the sensor data (from vibration sensors 102 and phase reference sensor 103) to reveal of the performance of vibrating equipment 120. Examples of process data can include operating parameters, process variables, control signals, and environmental conditions. Operating parameters can include parameters related to the operating conditions of the equipment, such as rotational speed, load, temperature, pressure, flow rate, and electrical power consumption. Monitoring these parameters helps correlate the vibration patterns with specific operating conditions, enabling better analysis and diagnosis of vibration issues. Analyzing the vibration data in conjunction with these process variables can provide insights into the interaction between the equipment's mechanical behavior and the process it is involved in. Process variables can include variables directly associated with the specific process being carried out by the vibrating equipment such as, in a centrifugal pump, discharge pressure, suction pressure, fluid level, or any other relevant measurements specific to the pumping process. Control signals are signals or parameters used for controlling and regulating the vibrating equipment (e.g., setpoints, control valve positions, control loop outputs, or other signals used to adjust the equipment's performance). Monitoring control signals alongside vibration data can help identify potential correlations between control actions and vibration responses. Environmental conditions, such as ambient temperature, humidity, or other environmental factors, may also be considered as part of the process data. These conditions can influence the behavior of the vibrating equipment and its components and monitoring them can help assess their impact on the vibration patterns observed.

By analyzing the vibration data in conjunction with the process data, implementations can provide insights into the relationship between the equipment's mechanical behavior and the process variables. Such integrated analysis allows for better diagnosis of vibration issues, understanding of the root causes, and the ability to implement appropriate maintenance and operational strategies to optimize equipment reliability and performance.

As illustrated, vibration sensor 101 can provide streams of input data obtained from real-time measurements. These streams of input data may initially be processed signal conditioning module 104. In some implementations, signal conditioning module involves preparing the raw data collected from vibration sensors for further analysis and interpretation. Examples of signal conditioning can include offsetting, filtering, amplification, or buffering. As illustrated, the conditioned raw data may then undergo analog filtration 105. As illustrated, the filtered and conditioned raw data from vibration sensors may then be digitized using ADC 106. In some configurations, streams of input data from phase reference sensor 102 may be digitized using ADC 106. In some cases, streams of input data from phase reference sensor 102 and process data 103 may feed directly into AI module 110.

When the raw data from input streams of vibration sensor and phase reference sensor are digitized, the digital data may be provided to time domain processing and buffer windowing 107. In various implementations, the window size can be adjusted for subsequent Fast Fourier Transform (FFT) processor 108, which generates the spectrum of digital signal in each window. As illustrated, the digital data from ADC 106, and the windowed data from windowing buffer 107, can both feed into AI module 110.

As illustrated, database 109 is coupled to AI module 110, as well as to receive output from FFT processor 108. Database stores past patterns of vibration, for example, vibration patterns that are correlated with faulty conditions on the rotary machinery. AI module 110 can be part of an enhance monitoring module resident in a condition monitoring software that can operate on offline vibration data (provided by portable data collectors) and/or online vibration data (provided by online condition monitoring systems or machinery protection systems). While the vibration sensors are used to identify the vibration response from different rotating equipment components, AI module 101 can establish baseline vibration response when a particular rotating equipment is new or recently overhauled. In this arrangement, the baseline establishes the “as new” baseline. Both vibration response and operating parameters can be “baselined” for the machine learning aspects. A deviation from the baseline would indicate a change in condition. Based on the existing historical data (e.g., data stored in database 109) and the data differentiation (i.e., transient or steady state), the AI module 110 can learn to identify incipient or developing failures and can present these failures accordingly. The AI module 110 can also learn to identify transient data due to load variation, rather than rotation-based variations (such as RPM variations).

AI module 101 can generate output for transient data 111 and steady state data 112. Transient data 111 can be in time domain or frequency domain. Steady state data 112 can likewise be in time domain or frequency domain. The transient data 111 and steady state data 112 can be provided to graphical control module 113, which can generate pre-defined plots 114. In some cases, the AI module 110 can directly drive graphical control module 113, or pre-defined plots 114. The generated plots can be provided to display 115.

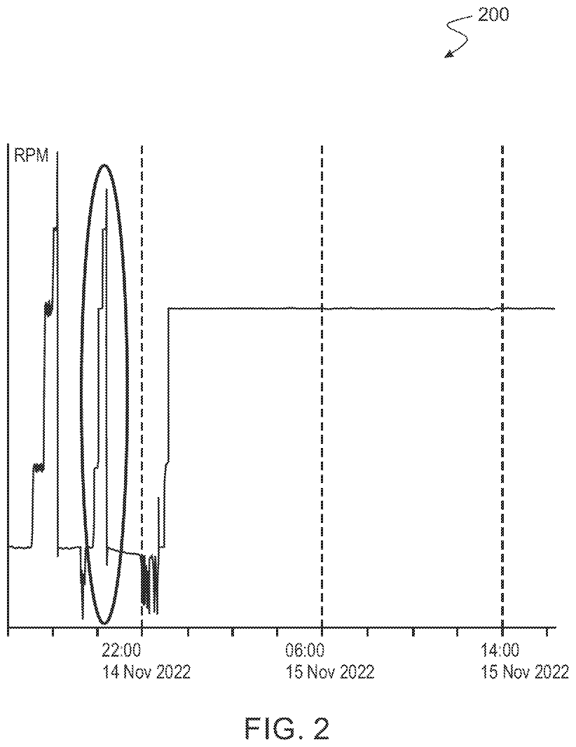

FIG. 2 shows an example of input data from vibration sensor 101 according to some implementation of the present disclosure. As illustrated, AI module 110 is connected to receive data provided by the condition monitoring system. By monitoring the streams of data from vibration sensors disposed on the rotary machinery, the AI module 110 can be trained to search for preset and self-developed conditions. For example, the AI module 110 can identify the critical data ranges once a faulty condition has been determined (e.g., based on historical and/or current data). The critical data range in this context refers to the data of interest, where the machine's dynamic behavior is abnormal. The example of FIG. 2 shows the range of interest with respect to the rotation per minute (RPM). This example is from a case study on a steam turbine. The turbine was unable to reach the rated RPM. The selection of the critical time range was based on the startup attempts, like the one indicated in the FIG. 2. By way of illustration, the relatively constant speed level seen after the indicated startup attempts correspond to the turbine slow-roll operation.

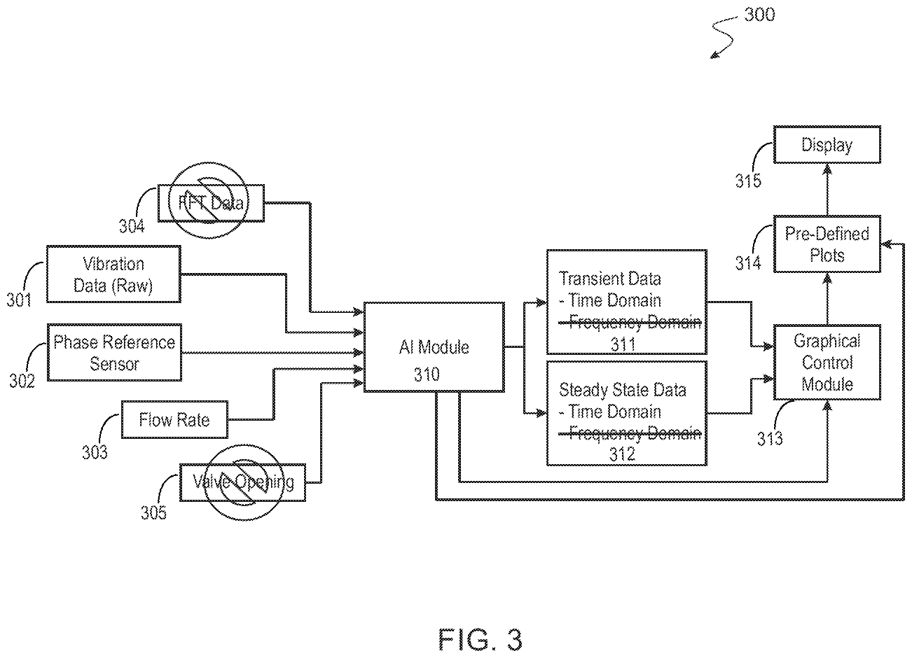

Based on the machine learning input, historical and current data, the AI module 110 operates to decide what streams of data to consider. For example, AI module 101 may focus on a few input streams of data such as shaft relative vibration or/and casing vibration, flow rate, bearing temperatures. FIG. 3 illustrates a system diagram for enhanced vibration monitoring according to some implementations of the present disclosure. As illustrated, AI module 310 selectively zeros in on vibration data 301, data from phase reference sensor 302, and flow rate data 303. The AI module 310 selectively neglects FFT data 304 and valve opening data 305 (which can be part of process data 103). The AI module 310 may operate on transient data in time domain (rather than the frequency domain) and steady state data in time domain (rather than the frequency domain). The AI module 310 may yield transient data 311 and steady state data 312 that feed graphical control module 313. The AI module 310 may directly drive graphical control module 313, or pre-defined plots 314. The generated plots can be provided to display 315.

Based on the available data that has been selected and the machine learning input (e.g., historical data, and weights of a model to be applied to available data), the AI module 310 operates to choose the data type for plotting and presentation that are relevant for the current situation.

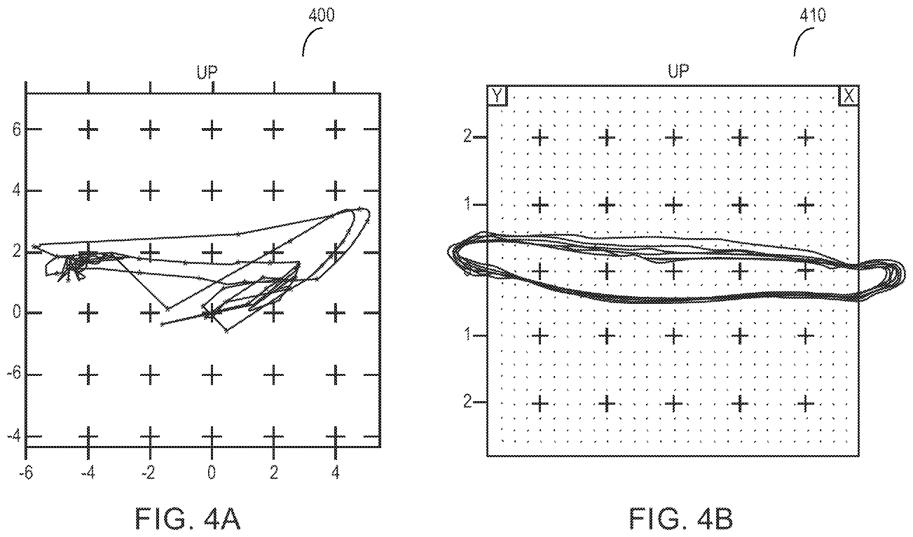

FIG. 4A is shaft centerline plot 400, which shows the position of the shaft inside a bearing housing with respect to the speed of the machine. In other words, FIG. 4A shows the wobbling pattern of shaft. FIG. 4B is an orbit plot 410, which shows the path of the shaft centerline motion during rotation using x and y-axes displacement transducers. FIGS. 4A and 4B, in combination, illustrate the full motion of the shaft position. The examples of FIGS. 4A and 4B are used to illustrate selecting these plots as the most relevant plots based on the algorithms used by AI module 310. For example, the algorithms of the AI module 310 may determine these two figures as the most discriminative (e.g., with the highest discriminative score) between normal and abnormal patterns). In some cases, the discriminative power can be established based on statistical comparison (e.g., t-test scores) that tests the separation between normal and abnormal conditions using a particular data type. In other cases, the discriminative power can be established based on feedback from analysts.

AI module 310 may aid in the decision on the proposed configurations, including the decision on whether the proposed configuration will be temporarily or permanently implemented to enhance the data quality and system performance. In some cases, an analyst can be presented with all the proposed system changes so that the analyst can decide accordingly. The decision of the analyst can be used as input for the machine learning (ML) algorithm so that the ML algorithm can learn from the analyst's decision. The analyst will be presented with options for selected data ranges, considered data streams, plots to be presented and suggested configurations. These are also to be considered inputs for the machine learning and AI interface.

The implementations of the present disclosure may present an improvement over known solutions. For example, known solutions can require an extensive time for the vibration analysts to accurately generate the most relevant plots for a critical troubleshooting case. The amount of data and the large number of signals can impede the process. For example, relevant data may be mistakenly discarded as some of the condition monitoring systems are trying to reduce the presented data due to hardware, communication bandwidth and video limitations.

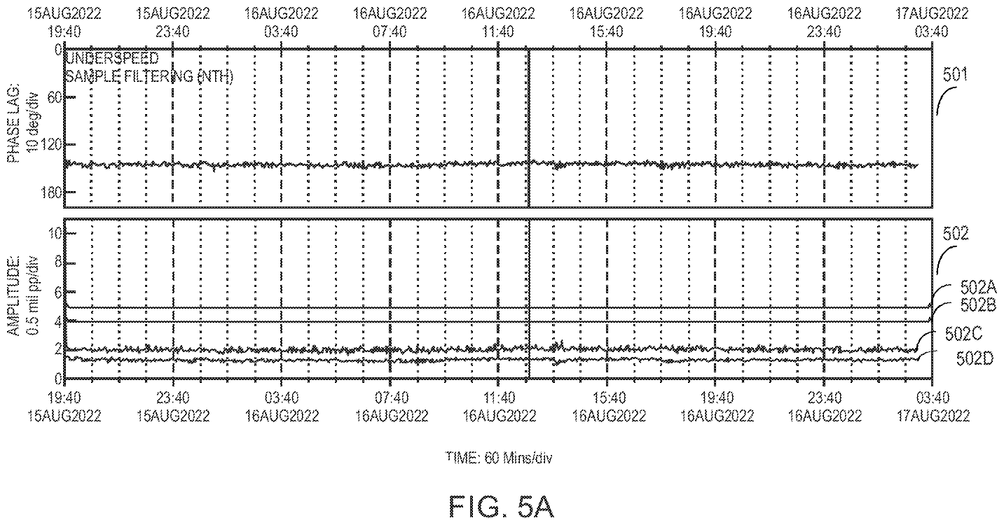

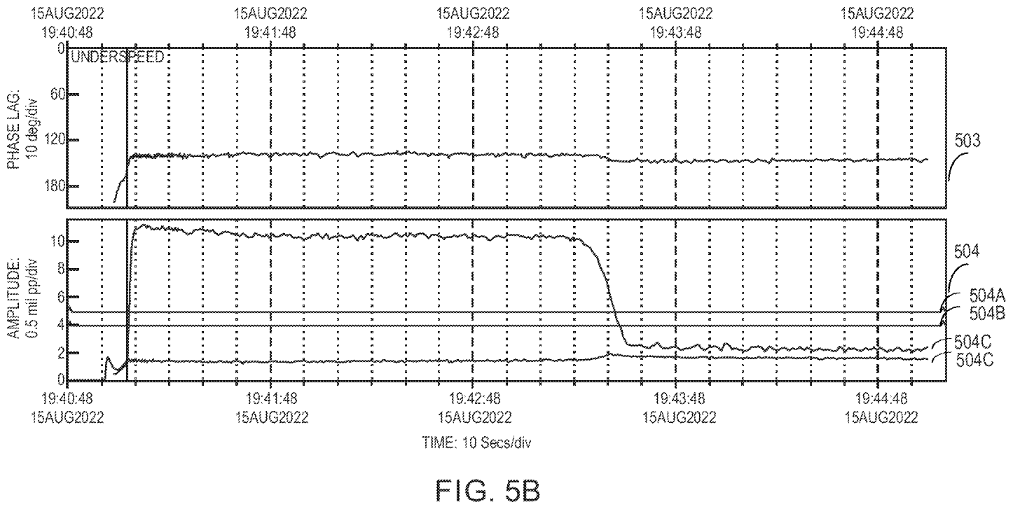

FIGS. 5A-SB illustrate examples of input data with transient event that can evade analysis in the absence of implementations of the present disclosure. Here, trace 501 represents the phase while trace 502 represents the amplitude of a vibration signal. Levels 502A to 502D may indicate varying levels of user attention. Level 502A corresponds to a danger level where operations can be halted. Level 502B corresponds to an alarm level where an alarm is triggered. Level 502C represents an overall level, which can be the envelop level. Level 502D represents a filtered level (where amplitude signals have been subjected to filtering). The recorded traces 501 and 502 have not shown the transient event. As such, these plots can induce an analyst into thinking, albeit erroneously, that the vibration level is well below the alarm limit when in fact it was a very short period when the vibration was extremely high, as revealed in traces 503 and 504 in FIG. 5B. Traces 503 and 504 represent a vastly distinct time scale from a contemporaneous temporal period as traces 501/502. Levels 504A to 504D likewise indicate varying levels of user attention. Level 504A corresponds to a danger level where operations can be halted. Level 504B corresponds to an alarm level where an alarm is triggered. Level 504C represents an overall level, which can be the envelop level. Level 504D represents a filtered level (where amplitude signals have been subjected to filtering). Using implementations of the present disclosure can effectively reduce, if not remove, such kind of issues because the AI module will be trained to extract and present relevant information at different scales. In the absence of tools provided by implementations of the present disclosure, a vibration analyst, will need to manually review a large quantity of plots (e.g., trends, orbits, polar, Bode, shaft centerline) and extract these plots based on time, transient phenomena, shaft speed. The extraction will lead to unrealistic analysis time based on human capabilities In other words, analyzing the volume of data generated at this speed by human mind is impractical.

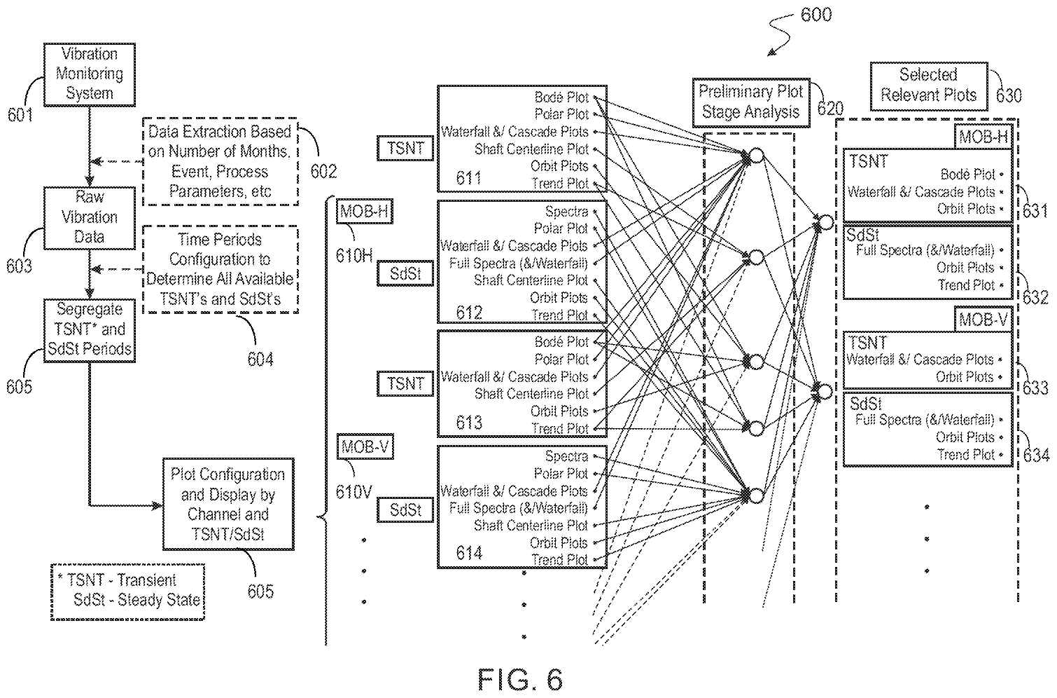

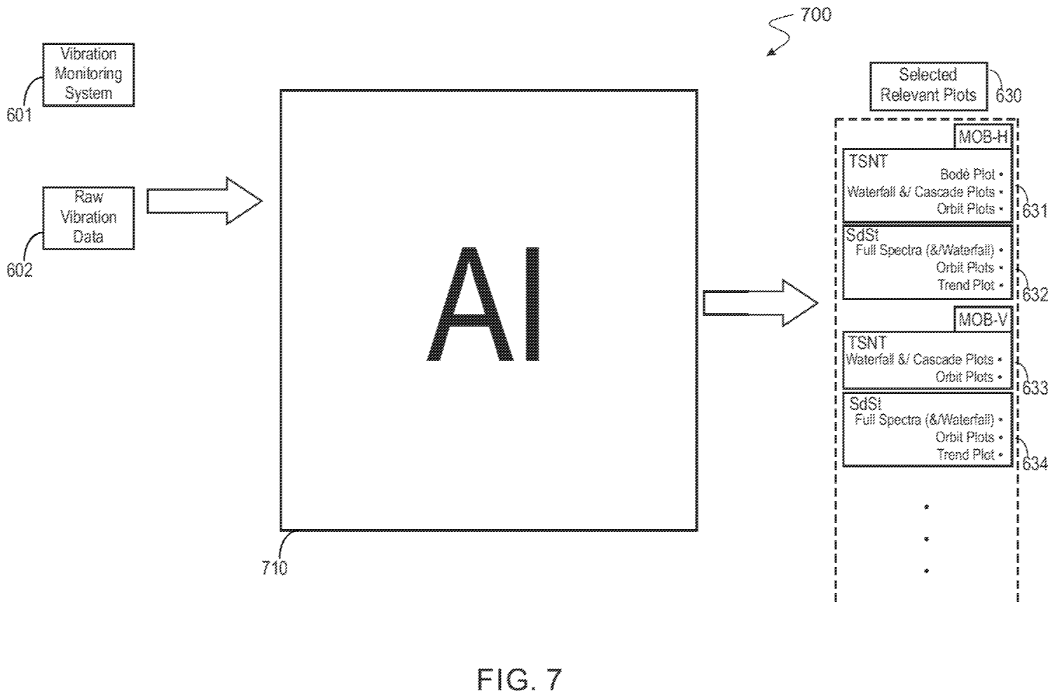

FIGS. 6-7 illustrate an examples of system diagrams according to some implementations of the present disclosure. FIG. 6 shows diagram 600 that includes vibration monitoring system 601. As explained above in association with FIGS. 1-4, raw vibration data 601 can be captured (e.g., using data extraction 602). Data extraction can be based on number of months, events, process parameters. Raw vibration data 603 can be segregated into transient and steady state periods (605). This segregation can be performed based on time periods configurations for determining the transient time periods and steady state time periods (604). The implementations may then provide plot configuration and display based on channel, transient time periods and steady state time periods (606). As illustrated, the plotting may include a motor outboard vertical section 610V (MOB-V) section and a motor outboard horizontal (MOB-H) section 610H. Section 610H includes a transient subsection 611 and a steady-state subsection 612. Subsection 611 can include a Bode plot, a polar plot, waterfall/cascade plots, shaft centerline plot, orbit plot, and trend plot. Examples of shaft centerline plot and orbit plot can be found in FIGS. 4A and 4B. Subsection 612 can include spectra, polar plot, waterfall/cascade plots, full spectra & waterfall, shaft centerline plot, orbit plot, and trend plot. Section 610V similarly includes a transient subsection 613 and a steady-state subsection 614 with comparable options. Preliminary plot state analysis 620 may incorporate logic layers configured to identify and extract the matching information (e.g., with respect to signals indicative of faulty conditions), and build sets of plots most capable of separating normal and abnormal conditions (e.g., during startup, steady-state or shutdown). As illustrated, using the preliminary plot state analysis 620, relevant plots may be selected (630). For example, in subsection 631 (transient) of the MOB-H section, Bode plot, waterfall/cascade plots, and orbit plots are selected, while full spectra & water fall plots, orbit plots, and trend plot are selected in subsection 632 (steady-state) of the MOB-H section. Similarly, in subsection 633 (transient) of the MOB-V section, Bode plot, waterfall/cascade plots, and orbit plots are selected, while full spectra & water fall plots, orbit plots, and trend plot are selected in subsection 634 (steady-state) of the MOB-V section. As summarized in FIG. 7, the functionalities associated with boxes 602, 604, 605, 606, 611, 612, 613, 614, and 620 can be performed by AI module 710 to generate the selected plots (630) for the MOB-H and MOB-V partitions with subsections 631, 632, 633, and 634. As explained above, the plotting and output mechanism leverages machine learning and data fusion to differentiate and filter vibration signals from physical sensors data such as accelerometer data, displacement, temperature, and valve position. The capability allows for precise and timely identification of deteriorating condition, thereby eliminating unnecessary failures and production loss. By analyzing parameters characterizing different physical aspects (e.g., displacement as related with vibration induced stress, velocity as directly proportional with amount of energy dissipated through vibration, and the acceleration as a direct indication of the amount of force involved in the physical phenomenon studied), the implementations can detect and predict the condition of a machine based on the full complement of machine performance. Neglecting the full records of measurements can lead to reduced accuracy of prediction.

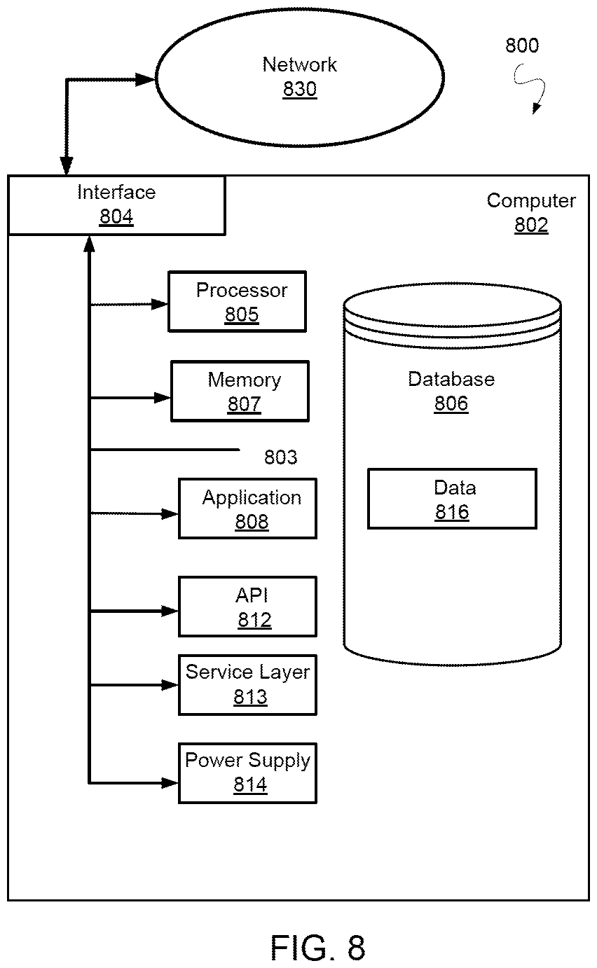

FIG. 8 is a block diagram 800 illustrating an example of a computer system 800 used to provide computational functionalities associated with described algorithms, methods, functions, processes, flows, and procedures, according to some implementations of the present disclosure. The illustrated computer 802 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 802 can comprise a computing device that includes an input device, such as a keypad, keyboard, touch screen, another input device, or a combination of input devices that can accept user information, and an output device that conveys information associated with the operation of the computer 802, including digital data, visual, audio, another type of information, or a combination of types of information, on a graphical-type user interface (UI) (or GUI) or other UI.

The computer 802 can serve in a role in a computer system as a client, network component, a server, a database or another persistency, another role, or a combination of roles for performing the subject matter described in the present disclosure. The illustrated computer 802 is communicably coupled with a network 830. In some implementations, one or more components of the computer 802 can be configured to operate within an environment, including cloud-computing-based, local, global, another environment, or a combination of environments.

The computer 802 is an electronic computing device operable to receive, transmit, process, store, or manage data and information associated with the described subject matter. According to some implementations, the computer 802 can also include or be communicably coupled with a server, including an application server, e-mail server, web server, caching server, streaming data server, another server, or a combination of servers.

The computer 802 can receive requests over network 830 (for example, from a client software application executing on another computer 802) and respond to the received requests by processing the received requests using a software application or a combination of software applications. In addition, requests can also be sent to the computer 802 from internal users, external or third-parties, or other entities, individuals, systems, or computers.

Each of the components of the computer 802 can communicate using a system bus 803. In some implementations, any or all of the components of the computer 802, including hardware, software, or a combination of hardware and software, can interface over the system bus 803 using an application programming interface (API) 812, a service layer 813, or a combination of the API 812 and service layer 813. The API 812 can include specifications for routines, data structures, and object classes. The API 812 can be either computer-language independent or dependent and refer to a complete interface, a single function, or even a set of APIs. The service layer 813 provides software services to the computer 802 or other components (whether illustrated or not) that are communicably coupled to the computer 802. The functionality of the computer 802 can be accessible for all service consumers using this service layer. Software services, such as those provided by the service layer 813, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 802, alternative implementations can illustrate the API 812 or the service layer 813 as stand-alone components in relation to other components of the computer 802 or other components (whether illustrated or not) that are communicably coupled to the computer 802. Moreover, any or all parts of the API 812 or the service layer 813 can be implemented as a child or a sub-module of another software module, enterprise application, or hardware module without departing from the scope of the present disclosure.

The computer 802 includes an interface 804. Although illustrated as a single interface 804 in FIG. 8, two or more interfaces 804 can be used according to particular needs, desires, or particular implementations of the computer 802. The interface 804 is used by the computer 802 for communicating with another computing system (whether illustrated or not) that is communicatively linked to the network 830 in a distributed environment. Generally, the interface 804 is operable to communicate with the network 830 and comprises logic encoded in software, hardware, or a combination of software and hardware. More specifically, the interface 804 can comprise software supporting one or more communication protocols associated with communications such that the network 830 or interface's hardware is operable to communicate physical signals within and outside of the illustrated computer 802.

The computer 802 includes a processor 805. Although illustrated as a single processor 805 in FIG. 8, two or more processors can be used according to particular needs, desires, or particular implementations of the computer 802. Generally, the processor 805 executes instructions and manipulates data to perform the operations of the computer 802 and any algorithms, methods, functions, processes, flows, and procedures as described in the present disclosure.

The computer 802 also includes a database 806 that can hold data 816 for the computer 802, another component communicatively linked to the network 830 (whether illustrated or not), or a combination of the computer 802 and another component. For example, database 806 can be an in-memory, conventional, or another type of database storing data 816 consistent with the present disclosure. In some implementations, database 806 can be a combination of two or more different database types (for example, a hybrid in-memory and conventional database) according to particular needs, desires, or particular implementations of the computer 802 and the described functionality. Although illustrated as a single database 806 in FIG. 8, two or more databases of similar or differing types can be used according to particular needs, desires, or particular implementations of the computer 802 and the described functionality. While database 806 is illustrated as an integral component of the computer 802, in alternative implementations, database 806 can be external to the computer 802. As illustrated, the database 806 holds data 816 including, for example, data from sensors disposed on rotary machinery, as explained in association with FIGS. 1-7.

The computer 802 also includes a memory 807 that can hold data for the computer 802, another component or components communicatively linked to the network 830 (whether illustrated or not), or a combination of the computer 802 and another component. Memory 807 can store any data consistent with the present disclosure. In some implementations, memory 807 can be a combination of two or more different types of memory (for example, a combination of semiconductor and magnetic storage) according to particular needs, desires, or particular implementations of the computer 802 and the described functionality. Although illustrated as a single memory 807 in FIG. 8, two or more memories 807 or similar or differing types can be used according to particular needs, desires, or particular implementations of the computer 802 and the described functionality. While memory 807 is illustrated as an integral component of the computer 802, in alternative implementations, memory 807 can be external to the computer 802.

The application 808 is an algorithmic software engine providing functionality according to particular needs, desires, or particular implementations of the computer 802, particularly with respect to functionality described in the present disclosure. For example, application 808 can serve as one or more components, modules, or applications. Further, although illustrated as a single application 808, the application 808 can be implemented as multiple applications 808 on the computer 802. In addition, although illustrated as integral to the computer 802, in alternative implementations, the application 808 can be external to the computer 802.

The computer 802 can also include a power supply 814. The power supply 814 can include a rechargeable or non-rechargeable battery that can be configured to be either user- or non-user-replaceable. In some implementations, the power supply 814 can include power-conversion or management circuits (including recharging, standby, or another power management functionality). In some implementations, the power-supply 814 can include a power plug to allow the computer 802 to be plugged into a wall socket or another power source to, for example, power the computer 802 or recharge a rechargeable battery.

There can be any number of computers 802 associated with, or external to, a computer system containing computer 802, each computer 802 communicating over network 830. Further, the term “client,” “user,” or other appropriate terminology can be used interchangeably, as appropriate, without departing from the scope of the present disclosure. Moreover, the present disclosure contemplates that many users can use one computer 802, or that one user can use multiple computers 802.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near (ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of media and memory devices, magnetic devices, magneto optical disks, and optical memory device. Memory devices include semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Magnetic devices include, for example, tape, cartridges, cassettes, internal/removable disks. Optical memory devices include, for example, digital video disc (DVD), CD-ROM, DVD+/−R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback. Input from the user can be received in any form, including acoustic, speech, or tactile input. In addition, a computer can interact with the user by sending documents to and receiving documents from a client computing device that is used by the user.

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between networks addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Furthermore, any claimed implementation is considered to be applicable to at least a computer-implemented method; a non-transitory, computer-readable medium storing computer-readable instructions to perform the computer-implemented method; and a computer system comprising a computer memory interoperable coupled with a hardware processor configured to perform the computer-implemented method or the instructions stored on the non-transitory, computer-readable medium.

What is claimed is:

1. A computer-implemented method comprising:
accessing streams of data encoding measurements taken at one or more pieces of rotating equipment;
accessing a database encoding past measurement records from the one or more pieces of rotating equipment;
identifying, using a processor configured to operate a machine learning (ML) module, relevant ranges of measurement values for at least a portion of the measurements encoded by the streams of data, wherein the ML module is adapted to predict the relevant ranges of measurement values based on, at least in part, the past measurement records from the one or more pieces of rotating equipment;
extracting, using the processor configured to operate the machine learning (ML) module, a subset of the at least a portion of the measurements, wherein the subset is identified by the ML module as more capable of distinguishing normal and abnormal operating conditions for the one or more pieces of rotating equipment than a remainder of the at least a portion of the measurements; and
generating, on a display device, at least one plot based on the subset of the at least a portion of the measurements and within the relevant ranges of measurement values such that the one or more pieces of rotating equipment are monitored continuously for deviations from the normal operating conditions.

2. The computer-implemented method of claim 1, wherein the measurements are taken from a plurality of sensors disposed at the one or more pieces of rotating equipment, a phase reference sensor disposed at the one or more pieces of rotating equipment, and
wherein the streams of data include process data associated with the one or more pieces of rotating equipment.

3. The computer-implemented method of claim 2, further comprising:
comparing a measured phase based on the measurements from at least one of the plurality of sensors and a reference phase from the phase reference sensor; and
generating at least one measurement based on results of comparing the measured phase and the reference phase.

4. The computer-implemented method of claim 2, wherein the plurality of sensors comprise at least one of: an accelerometer, a velocity sensor, a displacement sensor, a proximity sensor, and a strain gauge.

5. The computer-implemented method of claim 2, wherein the process data associated with the one or more pieces of rotating equipment include: a flow rate, a pressure, a temperature, and a valve position.

6. The computer-implemented method of claim 1, further comprising:
building the database that correlates the past measurement records from the one or more pieces of rotating equipment with operating conditions of the one or more pieces of rotating equipment.

7. The computer-implemented method of claim 6, wherein building the database further comprises:
receiving, from an analyst, data encoding a determination by the analyst that correlates at least one of the past measurement records from the one or more pieces of rotating equipment with at least one of the operating conditions of the one or more pieces of rotating equipment.

8. The computer-implemented method of claim 6, wherein the relevant ranges of measurement values cover a temporal range in addition to a vertical range for the measurement values.

9. The computer-implemented method of claim 6, wherein the subset of the at least a portion of the measurements comprise: a shaft centerline plot, an orbit plot, a Bode plot, a polar plot, a waterfall plot, a trend plot, and a trend plot.

10. The computer-implemented method of claim 1, wherein said generating provides, on the display device, two or more plots based on the subset, wherein the two or more plots are generated dynamically as the one or more pieces of rotating equipment are operating.

11. A computer system comprising one or more computer processors configured to operate a machine learning (ML) module and perform operations of:
accessing streams of data encoding measurements taken at one or more pieces of rotating equipment;
accessing a database encoding past measurement records from the one or more pieces of rotating equipment;
identifying relevant ranges of measurement values for at least a portion of the measurements encoded by the streams of data, wherein the ML module is adapted to predict the relevant ranges of measurement values based on, at least in part, the past measurement records from the one or more pieces of rotating equipment;
extracting a subset of the at least a portion of the measurements, wherein the subset is identified by the ML module as more capable of distinguishing between normal and abnormal operating conditions for the one or more pieces of rotating equipment than a remainder of the at least a portion of the measurements; and
generating, on a display device, at least one plot based on the subset of the at least a portion of the measurements and within the relevant ranges of measurement values such that the one or more pieces of rotating equipment are monitored continuously for deviations from the normal operating conditions.

12. The computer system of claim 11, wherein the measurements are taken from a plurality of sensors disposed at the one or more pieces of rotating equipment, a phase reference sensor disposed at the one or more pieces of rotating equipment, and
wherein the streams of data include process data associated with the one or more pieces of rotating equipment.

13. The computer system of claim 12, wherein the operations further comprise:
comparing a measured phase based on the measurements from at least one of the plurality of sensors and a reference phase from the phase reference sensor; and
generating at least one measurement based on results of comparing the measured phase and the reference phase.

14. The computer system of claim 12, wherein the plurality of sensors comprise at least one of: an accelerometer, a velocity sensor, a displacement sensor, a proximity sensor, and a strain gauge.

15. The computer system of claim 12, wherein the process data associated with the one or more pieces of rotating equipment include: a flow rate, a pressure, a temperature, and a valve position.

16. The computer system of claim 11, wherein the operations further comprise:
building the database that correlates the past measurement records from the one or more pieces of rotating equipment with operating conditions of the one or more pieces of rotating equipment.

17. The computer system of claim 16, wherein building the database further comprises:
receiving, from an analyst, data encoding a determination by the analyst that correlates at least one of the past measurement records from the one or more pieces of rotating equipment with at least one of the operating conditions of the one or more pieces of rotating equipment.

18. The computer system of claim 16, wherein the relevant ranges of measurement values cover a temporal range in addition to a vertical range for the measurement values.

19. The computer system of claim 16, wherein the subset of the at least a portion of the measurements comprise: a shaft centerline plot, an orbit plot, a bode plot, a polar plot, a waterfall plot, a trend plot, and a trend plot.

20. The computer system of claim 11, wherein said generating provides, on the display device, two or more plots based on the subset, wherein the two or more plots are generated dynamically as the one or more pieces of rotating equipment are operating.
